(19) United States
(12) Patent Application Publication
(10) Pub. No.: US 2021/0350188 A1
(43) Pub. Date: Nov. 11, 2021

(54) Pill Shape Classification using Imbalanced Data with Human-Machine Hybrid Explainable Model

(71) Applicant: George Mason University, Fairfax, VA (US)

(72) Inventor: William Franz Lamberti, Fairfax, VA (US)

(21) Appl. No.: 17/314,199

(22) Filed: May 7, 2021

Related U.S. Application Data
(60) Provisional application No. 63/021,693, filed on May 8, 2020.

(51) Int. Cl. G06K 9/62; G06N 5/00; G06N 3/02; G06N 20/10

(52) U.S. Cl. CPC G06K 9/6269; G06K 9/6202; G06N 20/10; G06N 5/003; G06N 3/02; G06K 9/6232

(57) ABSTRACT

A Human Machine Hybrid (HMH) pill shape classification system uses a decision tree with interpretable metrics. The disclosed approach for pill shape classification requires human intervention for determining the meta-classes and variables used. The creation of decision boundaries is accomplished with machine learning (ML) algorithms. Scatter plots are manually inspected to find candidate pairs of variables and potential meta-classes.

### CROSS-REFERENCE TO RELATED APPLICATIONS

The present application claims the benefit of priority to U.S. Provisional Patent Application No. 63/021,693 (filed on May 8, 2020), which is hereby incorporated by reference in its entirety.

### TECHNICAL FIELD

One or more embodiments are generally directed to a pill shape classification system, and, more particularly, to a highly accurate interpretable solution for pill classification using a human-machine hybrid approach that achieves a high overall classification rate and mean precision.

### BACKGROUND

A system to identify pills would be useful to global and local communities. Prescription drug use is on the rise in the United States. This increasing trend is not limited to the United States, as the United Kingdom faced a similar increase. In an exploratory study performed in Norway, over half of the thirty patients were given the wrong medication due to poor communication between health care officials. Deaths regarding opioids have also increased in the United States. Developing a system to improve the appropriate utilization and distribution of opioids is needed. A method to identify pills automatically is desirable by law enforcement agencies, the health care industry, and consumers.

The ubiquity of smart phones and affordable, high-quality cameras allows for users to take pictures effortlessly. This allows for pills to be potentially identified by both medical professionals and consumers. Nurses and medical technicians would be able to verify the administration of pills to patients. Multiple research communities have renewed interest in discriminating between fake and real prescription pills. Furthermore, the Food and Drug Administration (FDA) has advocated for creating a system to monitor patient opioid intake. The National Institute of Health's (NIH) National Library of Medicine (NLM) hosted a competition in response to some of these issues. Researchers have yet to find a perfect solution for pill identification.

Pill identification remains a challenging problem. Wong et al. (Y. F. Wong, H. T. Ng, K. Y. Leung, K. Y. Chan, S. Y. Chan, C. C. Loy, “Development of fine-grained pill identification algorithm using deep convolutional network”, Journal of Biomedical Informatics, 74 (2017) pp. 130-136) created a convolutional neural network (CNN) to identify pills that has a mean overall accuracy of 95.35%. However, they continue to say “From the clinical practicality point of view, [the] accuracy rate . . . [of our model] is still rather low to allow unsupervised, fully automated pill identification”. The inherent opaqueness of CNNs makes it difficult to diagnose which aspects of the mode work and which fail (J. Gu, Z. Wang, J. Kuen, L. Ma, A Shahroudy, B. Shuai, T. Liu, X. Wang, G. Wang, J. Cai, T. Chen, “Recent advances in convolutional neural networks”, Pattern Recognition, 77 (2018) pp. 354-377).

A solution to classification problems is to create a unique system for the given application. For instance, Maddala et al. (K. T. Maddala, R. H. Moss, W. V. Stolecker, J. R. Hagerty, J. G. Coile, N. K. Mishra, R. J. Stanley, “Adaptable Ring for Vision-Based Measurements and Shape Analysis”, IEEE Transactions on Instrumentation and Measurement, 66 (2017) pp. 746-756) built a model for classifying medical pills using adaptable rings and a human-machine hybrid (HMH) decision tree. Maddala et al. provide two additional models to compare against their proposed model. The first is a neural net using the derived adaptable ring metrics. The second is a logistic regression model using seven Hu moments. Both of these methods are machine driven approaches. Hu moments are popular shape metrics that have desirable theoretical properties such as invariation to orientation (M.-K. Hu, “Visual Pattern Recognition by Moment Invariants”, IRE Transactions on Information Theory, 8 (1962) pp. 179-187; J. Flusser, T. Suk, “Affine moment invariants: a new tool for character recognition”, Pattern Recognition Letters, 15 (1994) pp. 433-436; R. C. Gonzalez, R. E. Woods, S. L. Eddins, “Digital Image Processing Using METLAB, 2nd ed. By Rafael C. Gonzalez, Gatesmark Publishing, S. I. 2nd edition, 2009). Unfortunately, Hu moments do not appear to provide any meaningful insight for discriminating medical pill shapes.

While the neural network has a large overall classification rate, it misclassified rectangle, round, oval, and capsule classes and consumes significant processing power. Maddala et al.'s approach using Hu moments completely misclassified entire classes. Thus, the medical pill classification problem warranted an improved approach with high accuracy, reduced processing power and significantly less processing time.

Maddala, et al.'s third model, the HMH tree, is based on a series of metrics derived from adaptable rings. They used 2,151 pill images with 14 shape classes. They retrieved the data in December 2014. Their approach had very few observations of particular classes at the time of their analysis. For instance, the December 2014 data only had one octagon.

Their image processing steps have some issues. Maddala et al. treat classes differently during the image processing steps. For example, they center the pill for the oval, capsule, rectangle, and trapezoidal classes using the bounding box center. They calculated a different centroid as the center for the other classes. This is a problem as the classes' features are treated and measured differently.

Another issue with the Maddala et al. model is that it requires human inputs. CNNs are a popular modeling technique for classifying images in the computer vision community that require no human inputs (K. Fukushima, “Neocognitron: A self-organizing neural network model for a mechanism of pattern recognition unaffected by shift in position”, Biological Cybernetics, 36 (1980) pp. 193-202; Y. LeCun, B. E. Boser, J. S. Denker, D. Henderson, R. E. Howard, W. E. Hubbard, L. D. Jackel, “Handwritten Digit Recognition with a Back-Propagation Network”, in: D. S. Touretzky (Ed.), Advances in Neural Information Processing Systems 2, Morgan-Kaufmann, 1990, pp. 396-404). One example of a popular CNN is AlexNet (A. Krizhevsky, I. Sutskever, G. E. Hinton, “ImageNet Classification with Deep Convolutional Neural Networks”, Advances in Neural Information Processing Systems, 25 (2012) pp. 1097-1105). CNNs are used on many different discrimination problems such as medical pill similarity (X. Zeng, K. Cao, M. Zhang, “MobileDeepPill: A Small-Footprint Mobile Deep Learning System for Recognizing Unconstrained Pill Images”, in: Proceedings of the 15th Annual International Conference on Mobile Systems, Applications, and Services, MobiSys '17, ACM, New York, N.Y., USA, 2017; J. Wang, S. Mall, L. Perez, “The Effectiveness of Data Augmentation in Image Classification using Deep Learning”, arXiv: 1712.04621 (2017) 8) medical person identification (N. Pattisapu, M. Gupta, P. Kumaraguru. V. Varma, “A distant supervision based approach to medical persona classification”, Journal of Biomedical Informatics, 94 (2019) 103205), and face recognition (O. M. Parkhi, A. Vedaldi, A. Zisserman, “Deep Face Recognition”, in: Proceedings of the British Machine Vision Conference 2015, British Machine Vision Association, Swansea, 2015, pp. 41.1-41.12). One of the reasons analysts and modelers use CNNs is due to their high predictive performance. Unfortunately, CNNs are difficult to interpret and computationally expensive. Compounding this difficulty further is that some entities require a right to explanation (e.g., a right to be given an explanation for an output of the algorithm) when AI is employed. CNNs as noted are difficult to interpret and thus there is difficulty in meeting the requirements of the right to explanation.

While the larger classes of capsule, round, and oval were not included, Maddala et al. attempted to discriminate classes such as triangle or square with less observations. However, these models performed worse than Maddala et al.'s adaptable ring based model when confined to the same classes. Thus, there is no machine-driven model which can effectively classify pill shapes in the literature.

### SUMMARY

Some examples include a pill shape classification system, comprising an imaging device to obtain one or more pill images of a pill to be processed, at least one processor, and at least one memory having a set of instructions. The set of instructions which when executed by the at least one processor, causes the pill shape classification system to extract one of more features from the one or more pill images, and classify the one or more features into one or more classifications based on a decision tree having a plurality of nodes and a plurality of leafs, each node using a classification algorithm, and each node pointing directly or indirectly to one or more of the plurality of leafs uniquely describing a classification that includes a pill shape, a pill text, or a pill color.

Some examples include a method of classifying one or more pills. The method comprises obtaining one or more pill images of a pill to be processed, extracting one of more features from the one or more pill images, and classifying the one or more features into one or more classifications based on a decision tree having a plurality of nodes and a plurality of leafs, each node using a classification algorithm, and each node pointing directly or indirectly to one or more of the plurality of leafs uniquely describing a classification that includes a pill shape, a pill text, or a pill color.

Some examples include at least one computer readable storage medium comprising a set of instructions. The set of instructions which when executed by a computing device, causes the computing device to obtain one or more pill images of a pill to be processed, extract one of more features from the one or more pill images, and classify the one or more features into one or more classifications based on a decision tree having a plurality of nodes and a plurality of leafs, each node using a classification algorithm, and each node pointing directly or indirectly to one or more of the plurality of leafs uniquely describing a classification that includes a pill shape, a pill text, or a pill color.

### BRIEF DESCRIPTION OF THE DRAWINGS

FIG. 1 is a representation of an example of a pill from the triangle class;

FIG. 2 illustrates an example of the capsule image before the image segmentation was performed;

FIG. 3 illustrates in example of the capsule image shape of FIG. 2 after the image segmentation was performed;

FIG. 4 provides an example of the SPEI algorithm result with a reference circle where the SPEI algorithm will put the triangle in the minimum encompassing circle and then the region in the minimum encompassing square;

FIG. 5 is a graph which shows the SP and Eccentricity values;

FIG. 6 is a graph which shows the EI values of the pill shapes;

FIG. 7 is a graph which shows the minimum bounding box black and white pixel counts for the shape data;

FIG. 8 illustrates an example of the regular hexagon image before image segmentation was performed;

FIG. 9 illustrates an example of the non-regular hexagon image before the image segmentation was performed;

FIG. 10 is a graph which shows the decision boundary made using the training data on a first node;

FIG. 11 is a diagram showing a resulting decision tree;

FIG. 12 is a generalized flow diagram illustrating a process implemented by embodiments;

FIG. 13 is a specific flow diagram illustrating the process for pill shape classification;

FIGS. 14A and 14B, taken together, are a flow diagram illustrating in more detail the process for generating a decision tree for pill shape classification;

FIG. 15 is a block diagram illustrating the pill identification system according to embodiments;

FIG. 16 is a flow diagram illustrating the process of fake pill identification according to an embodiment;

FIG. 17 illustrates an example of a method for detecting a pill shape;

FIG. 18 illustrates an example of an iterative method for detecting a pill shape; and

FIG. 19 illustrates an example of a pill processing system.

### DETAILED DESCRIPTION

One or more embodiments implement a Human-Machine Hybrid (HMH) decision tree with a various metrics (e.g., seven metrics). This model outperforms other approaches (e.g., CNN and/or other black box approaches) including those described above and implements new and enhanced computer functionality to accurately classify pills. For example, it may be desirable to build separate models for pill shape classification, pill color identification, and pill text identification to increase accuracy while also reducing the vast processing power that a CNN by itself would consume to identify a shape for example.

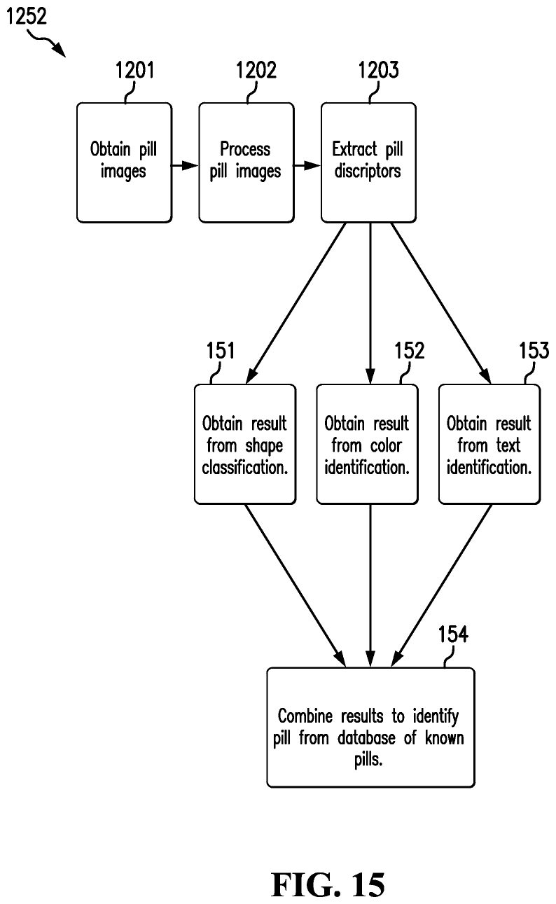

For example, and turning to FIG. 15 (which will be described in further detail below) a first decision tree may be referenced to obtain a shape classification 151 of a pill, a second decision tree may be referenced to obtain a color identification 152 of the pill, and a third decision tree may be referenced to obtain a text classification 153 of the pill. Further, by building separate models for pill shape classification, pill color identification, and pill text identification that were all interpretable, some embodiments combine the three models into a single interpretable method for pill identification as shown in processing block 154. This approach enables a better understanding of why and how certain approaches fail or succeed, as opposed to CNNs, which in turn allows significantly more accurate classifications.

Moreover, the separation of the three decisions (e.g., shape, text, and color decisions) into different decision trees (e.g., HMH decision trees) enables an accurate, granular and refined process that utilizes less processing power than other implementations while also achieving more accurate results. For example, rather than using a single CNN to interpret all aspects of a pill to identify the pill, some embodiments utilize three different decision trees that are independent of each other and process different aspects of the pill. The three different decision trees may each include plurality of nodes and a plurality of leafs, each node using a classification algorithm (e.g., a support vector machine, described below) and each node pointing directly or indirectly to one or more of the plurality of leafs uniquely describing a classification that includes a pill shape, a pill text, or a pill color. The results are then combined to determine a final categorization of the pill. One or more embodiments may utilize at least one decision tree to identify at least one characteristic (e.g., shape), but may further include one or more CNNs to identify one or more other characteristics (e.g., color and text).

The automated process results in several technical advantages, including reducing or eliminating misclassified pills, errors, and miscalculations by verifying the state and nature of pills with a high degree of granularity and precision. Thus, embodiments of the present application improve the functioning of a computer and improves a technology and/or technical field of automated pill identification.

Further yet, the above automated process is far more robust and efficient than any manual process and removes human subjectivity, error, and waste. For example, implementations of the present application would be difficult, if not impossible, for a person to mentally execute. As a more specific example, some embodiments rely on high quality imaging devices to retrieve high quality images of pills. Thus, minute deviations, that may be imperceptible by human being, may be detected and analyzed to determine the type of pill, and whether the pill is counterfeit (e.g., a small deviation from an expected size of a genuine pill may indicate that the pill is a counterfeit pill) and/or damaged in some fashion to be unusable. Moreover, it would be difficult if not impossible for a human being to store a vast body of knowledge that includes characteristics (e.g., shape, type, and color) of every pill. Thus, human subjectivity (e.g., biased and limited human experiences) may be eliminated by generating pill identifications based on a vast body of knowledge that is readily accessible.

One or more embodiments include a decision tree comprising a plurality of nodes. Each node is trained using observations (e.g., a max of 113). Of these observations, a majority (e.g., 75) came from the three largest classes: round, capsule and oval. Each of these classes contributed an equal (e.g., 25) observations. The remaining classes used half of the total number of observations for the training data. This ranged from two to six observations for a given class. Each decision node utilized two variables with a support vector machine (SVM). A SVM is a supervised machine learning model that uses classification algorithms for two-group classification problems. As used in the present application, the SVM uses a polynomial kernel which allows users to interpret the results with ease.

First, as will be discussed hereinbelow, one or more embodiments describe the shape identification and a general description of the HMH decision tree. Doing so illustrates how the one or more embodiments and metrics are interpretable by a human. Second, one or more embodiments, elaborate on the construction and performance of the HMH decision tree. This shows that the present model is the best model at present for pill shape classification. One or more embodiments further mention the pertinent aspects of the model. Fourthly, one or more embodiments describe the model as being competitive and interpretable, the variables included in some embodiments, and how some embodiments improve shape metric collection over previous implementations, and how the present approach is a combination of machine and human learning.

One or more examples classify pills using a multi-prong approach that evaluates different characteristics of a pill.

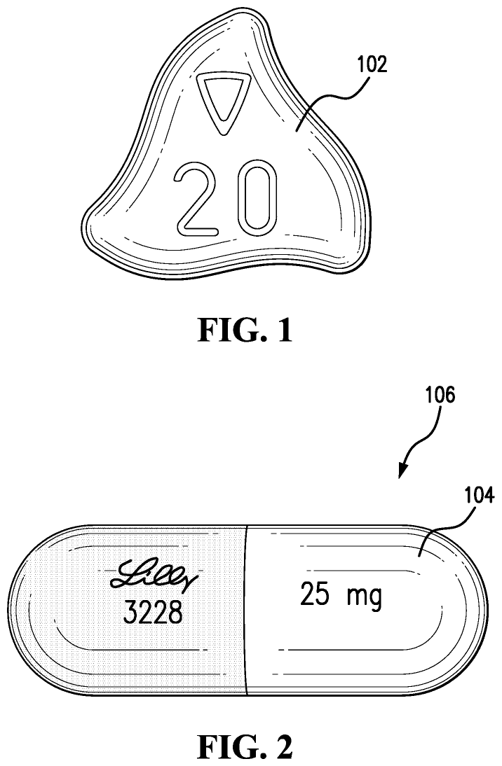

Turning now to FIGS. 1 and 2, a first pill 102 and a second pill 104 are illustrated. The first pill 102 is distinct in shape, color, and text from the second pill 104. One or more embodiments as described herein may analyze distinct characteristics (e.g., the shape, color, and text) of the first pill 102 and the second pill 104 to distinguish between the first pill 102 and the second pill 104. For example, a first decision tree with a plurality of nodes may be employed to determine the shape (e.g., triangular) of the first pill 102. A second decision tree with a plurality of nodes may be employed to determine the color of the first pill 102 (e.g., black) of the first pill 102. A third decision tree with a plurality of nodes be employed to determine whether any text is present on the first pill 102. If text of the first pill 102 is identified, some embodiments may employ various techniques (e.g., optical character recognition, etc.) to affirmatively identify the text. One or more embodiments may combine the shape, the color, and the text to identify a final category (e.g., a type such as Xarelto) of the first pill 102. For examples, the shape, the color, and the text may be compared to a database to identify a pill that has the shape, the color and the text. The database may be a comprehensive database that stores the shape, the color, and the text for each of a plurality of pills.

Likewise, the first, second, and third decision trees may provide outputs indicating the shape, the color, and the text of the second pill 104. One or more embodiments may combine the shape, the color, and the text to identify a final category (e.g., a type such as Advil Liqui-Gels) of the second pill 104 based on the database.

Each node of the first, second, and third decision trees may employ SVM that provides a binary classification (e.g., assign one of two classifications to an input). The first, second, and third decision trees may include multiple nodes arranged in a hierarchy, with each node leading to either a decision (e.g., classification) or another node.

One or more embodiments access a public database to retrieve training data (e.g., National Institute of Health (NIH) National Library of Medicine (NLM) reference data from the recent 2016 Pill Image Competition). The provided reference images from the competition contain 2,000 JPEG files with a total of 12 classes. For example, there may be a total of 1,000 unique pills, each with a front and back view taken from the database (e.g., NLM RxIMAGE database). The images have a grayish toned background and no shadows, are centered and have similar image qualities (e.g., sheen). FIG. 1 shows an example of one such image that includes the pill 102. The data source did not provide a table with the classes. Thus, the data set was manually classified.

Table 1 shows the pill shape classes' counts for each of the datasets and may include shapes not officially recognized by some authorities (e.g., NIH) For example, “hexagon” class may be split into another class called “hexagon (shield)” or “shield”. One or more documentation considers “shields” to be a part of a “freeform” class. Maddala et al. claimed that the “double circle” class is a part of the “freeform” class. However, both data sets' overlapping classes have similar numbers of observations. This permits performance analysis on similar footing to Madalla et al. analysis for comparison.

Table 1 shows the classes and counts of the classes of the NLM NIH reference data and the NIH Pillbox data accessed by Maddala et al. in December 2014.

TABLE 1

| Class | Training Data | Maddala et al. Count |
|---|---|---|
| Capsule | 332 | 243 |
| Diamond | 12 | 8 |
| Freeform | — | 6 |
| Hexagon | — | 3 |
| Octagon | — | 1 |
| Oval | 688 | 790 |
| Pentagon | 12 | 8 |
| Rectangle | 6 | 4 |
| Round | 904 | 1054 |
| Semi-circle | 4 | — |
| Shield | — | 5 |
| Square | 8 | 7 |
| Tear | 10 | 9 |
| Trapezoid | 4 | 3 |
| Triangle | 12 | 10 |

One or more or more examples first obtain binary shapes, or a white shape on a black background, of the pills through a segmentation process. The entire training data set is passed through a single segmentation algorithm which is enhanced relative to other approaches that require knowledge of the class before segmentation is performed. The shape segmentation algorithm is defined as:

func{bold b}_i [{x vec}]={I}_{(1)} {B} ┌ _{>0} GL _{func L} func{bold a}_i [{x vec}](1) [Equation 1],

where func {bold a}_i [x vec] is the input image, i ∈ {1, 2, . . . , 2000}, L_{L} converts the image to grayscale, G is the gradient operator, ┌ is the threshold operator where the intensities greater than 0 are retained, B is the binary fill hole operator, and I₍₁₎ is the isolation operator where only the largest object is retained.

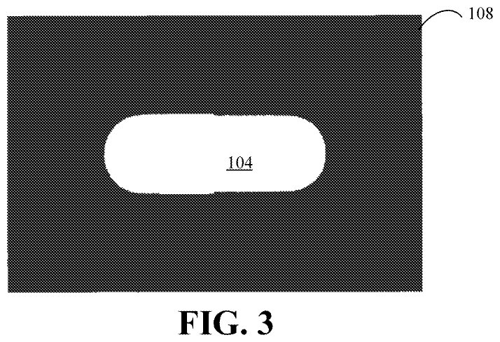

One or more embodiments first convert the image to grayscale to reduce the dimension of the images. One or more embodiments then find the gradient so that the edges in the image are retained. One or more embodiments then only retain the positive gradient values to binarize the image. One or more embodiments then fill in all of the retained binarized edges to create solid objects. Lastly, One or more embodiments extract the largest object in the image and assume that to be the pill shape. Examples of the result of offunc {bold a}_i [x vec] andfunc {bold b}_i [x vec] are provided in FIGS. 2 and 3, respectively. That is, FIG. 2 shows a first image 106 with the second pill 104 (which would be in color for processing by a computing system), and FIG. 3 shows a second image 108 based on the first image 106. For example, the first image 106 may undergo a binarization process to generate the second image 108.

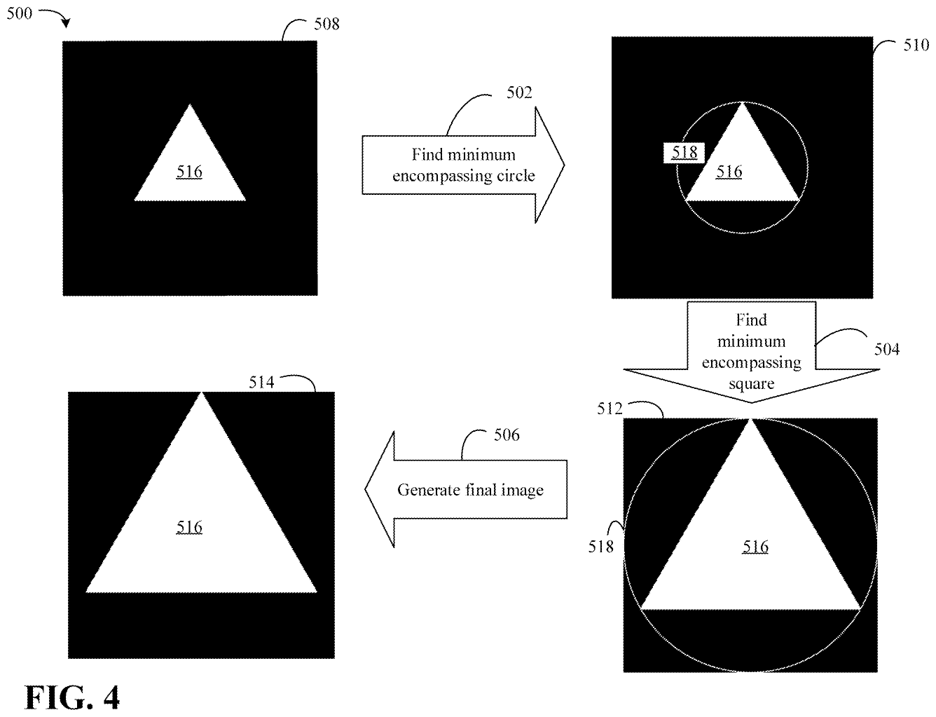

One or more examples collect and analyze various metrics. The first metrics were the Shape Proportions (SPs) and Encircled Image-histograms (EIs). Embodiments collect these from a Shape Proportion and Encircled Image-histogram (SPEI) algorithm. The other shape metrics were eccentricity, circularity, and the white and black pixel counts from a minimum bounding box (described in further detail with respect to FIG. 4). This results in a total of seven total metrics used for the HMH decision tree model. Each metric has an intuitive meaning. This makes a resulting model more interpretable.

Shape proportions and encircled image-histograms (SPEIs, which is pronounced “spies”) is an image operator algorithm. The algorithm explained mathematically, and the conclusions of the final plot created are interpretable by a human. Furthermore, the applications for SPEIs are varied, as SPEIs may be built upon using other methods. For a given application, a user may alter the approach to fit the specific problem a user is solving.

One or more embodiments apply SPEIs to any 2D binary shape. A SPEI is particularly powerful when the shape has a unique value for the shape proportion (SP). The SP is the proportion of white pixels resulting from SPEIs. A SP value corresponds to an encircled image-histogram (EI). The EI is the resulting black and white pixel counts. Thus, the SPEI image operator algorithm has two resulting metrics: the SP and EI values. In short, SPEIs puts the shape in the minimally encompassing circle. This is then placed inside the minimal encompassing square. The circle is placed in a square, as most digital images are composed of square pixels. In some embodiments, a user or computing device could apply SPEIs by placing the encompassing circle inside any desired shape, like a hexagon.

One of the benefits of SPEIs is that users can use the resulting EI values by a variety of different classification algorithms. For analysis, quadratic discriminant analysis (QDA), support vector machines (SVMs), logistic regression (LR), and trees are examples of classification algorithms that some embodiments use to discriminate the observations based on the EIs. Thus, users may use SPEIs in a variety of classification techniques.

One or more embodiments collect the encircled image-histograms (EIs) using SPEI. This algorithm results in a vector {c vec}_{EI} which contains the white and black pixel counts. These counts are the first two metrics, {m vec}_1 and {m vec}_2, respectively. The Shape Proportion (SP) value for a given image, i, is:

{m vec}_{3, i}={{m vec}_{1, i}} over {{m vec}_{1, i}+{m vec}_{2, i}} [Equation 2].

The SP value is essentially the proportion of white pixels after applying the SPEI algorithm. This SPEI algorithm puts a shape in its minimum encompassing circle. Then the circle is placed in its minimum encompassing square. FIG. 4 provides an example of the SPEI algorithm reflected in a process 500 that produces a resulting final image 514. A first image 508 illustrates a pill. The pill 516 is imaged in black and white. The lettering (if at any) on the pill 516 is removed from the first image 508 and replaced with white pixels. Thus, in some embodiments, the lettering may be ignored and/or bypassed from consideration in process 500. The process 500 includes finding a minimum encompassing circle 518, 502 as illustrated in second image 510. The minimum encompassing circle 518 encompasses the pill 516 and connects with each vertex of the pill 516. The process 500 includes finding a minimum encompassing square 504. Areas outside of the minimum encompassing circle 518 may be removed (e.g., cropped) from the second image 510 to generate third image 512. The third image 512 illustrates the minimum encompassing square with the minimum encompassing circle 518 and the pill 516. The minimum encompassing circle 518 is removed from the third image 512 to generate final image 506, 514. The EIs are the white and black pixel counts in the final image 514 after applying SPEIs. The SPs and EIs are a natural fit for a pill shape classification model since they were developed to analyze regular polygons and circles.

Eccentricity (major access length over minor axis), circularity, and the white and black pixel counts from the minimum bounding box had additional image operators performed after func {bold b}_i {x vec} was obtained. Th additional image operators include:

func {bold c}_i [x vec] ˜=˜ [symbol] _{20} ˜ [symbol] _{20}˜ ┌ _{>0.99} S_{1.5} func {bold b}_i [x vec] [Equation 3],

where S is the Gaussian smoothing operator with a standard deviation of 1.5 and [symbol] and [symbol] are the erosion and dilation operators, respectively, with a total of 20 iterations each. These operators were performed to obtain more discriminative values.

One or more embodiments calculate eccentricity by finding the ratio of the first and second eigenvalues. To obtain the eigenvalues, some embodiments execute:

{e vec}_i ˜=˜ func E_{1, 2} V func {bold c}_i [x vec] [Equation 4],

where V collects the covariance matrix of the shape matrix and E_{1, 2} calculates the first and second eigenvalues of the resulting covariance matrix. The j^{th} eigenvalue on image i is e vec_{i, (j)}.

Thus, to obtain m vec_4, eccentricity (which corresponds to Equation 4), some embodiments perform on a given image, i, the following:

{m vec}_{4, i}=˜ {{e vec}_{i, (1)}} over {{e vec}_{i, (2)}} [Equation 5]

It is understood that the eigenvalues of a covariance matrix correspond to the linear combination in the data which maximizes the variance for their respective dimension. For instance, the first eigenvalue is the linear combination of the data which maximizes the first eigenvalue. Moreover, the linear projections, or eigenvalues, are orthogonal to one another. Thus, the eigenvalues are measures of the major and minor axes of our given shape. Using the ratio of the major and minor axes provide some insight to how a given shape exists as a 2D digital image. A value close to 1 corresponds to a shape with the same major and minor axes' lengths. A value greater than 1 corresponds to the case where the major axis length is larger than the minor axis length. The limit of eccentricity would correspond to the case where the major axis length is infinitely larger than the minor axis length.

The next metrics were the black and white pixel counts from the minimum bounding box. The metrics were collected on image i by:

{h vec}_i=H₂ B {bold c}_i [{x vec}] [Equation 6],

where B finds the minimum bounding box of the input image, and H₂ calculates the binary image histogram, or binary intensity histogram, of the bounding box image. The result is a vector of the counts of the white and black pixels, which are represented by h_{i, w} and h_{i, b}, respectively.

Thus, the metrics m₅ and m₆ (the white and black pixel counts of the image in a minimum bounding box) are:

{m vec}_{5, i} ˜=˜ h_{i, w} [Equation 7],

and {m vec}_{6, i} ˜=˜ h_{i, b} [Equation 8].

These values describe how rectangular a given shape is. If a given pair has a very large white count, but a very small black count, then this given shape is fairly rectangular.

The last metric, {m vec}_7, is circularity. The metric was collected on image i by:

{m vec}_{7, i}={sum func {bold c}_i [{x vec}]} over {4pi times left(sum [symbol] func{bold c}_i [{x vec}] −sum func {bold c}_i [x vec] right)} [Equation 9],

where Σ sums the pixel intensity values. The Σ operator will compute the area of the image since we are restricted to binary images. The denominator of this metric is the perimeter of the binary image multiplied by 4π. Circularity provides a measure for how circular a shape is as a 2D digital image. A value of 1 corresponds to a perfect circle.

All of the variables used in the analysis have interpretable meanings and are used to identify the final shape of the pill. This will aid in the interpretation of each of our model's nodes. Table 2 provides a summary of the variables or metrics collected for this analysis. Table 2 provides the metrics used in this analysis on a given image, i. The first column is the q^{th} metric, where q ∈ {1, 2, 3, 4, 5, 6, 7} and correspond to the metrics above. These models make our model interpretable.

TABLE 2

| {m vec}_{q, i} | Metric |
|---|---|
| 1 | White El |
| 2 | Black El |
| 3 | SP value |
| 4 | Eccentricity |
| 5 | White Bounding Box Count |
| 6 | Black Bounding Box Count |
| 7 | Circularity |

One or more embodiments generate and build a HMH decision tree to discriminate the classes. The HMH decision tree includes Support Vector Machines (SVM) with a polynomial kernel at each node. Each node's SVM used only two variables. We considered the variables by observing the scatter plots of the complete data. One or more embodiments are constricted to only using two variables at each node to allow the decision tree to be significantly more interpretable. Each node had an associated scatter plot with the resulting decision boundary from the SVM algorithm.

One or more embodiments group the classes into larger groups (meta-classes) at each node for a number of reasons. The first is a practical one, as an imbalanced dataset (e.g., unequal distribution of classes) may be utilized. Initial models optimized using overall accuracy. Models using all of the metrics and 12 distinct classes (e.g., to reflect different shapes) would categorize the smaller classes as observations belonging to one of the larger classes.

The second reason was due to the restriction of using only two variables at each decision node due to the application of the SVM algorithm, which can process only two variables at a time. A straightforward method of inspecting one's data is to use a 2D scatter plot. Thus, imposing the constraint of using two variables on the modeling procedure always ensured that we could easily inspect a given decision node for evaluation. There was not a single pair of collected metrics which could separate all the classes with a high level of performance. However, the pairs of variables could separate between meta-classes (e.g., larger classes) well. Thus, we adopted this approach as it was effective for classification.

The third reason for using meta-classes is that this solution is elegant in design. It may be possible to define a complicated loss function or modeling algorithm. However, some embodiments include a solution that is easily explainable to a wide technical audience and is also highly competitive. Each node of the model was optimized using overall classification. Each node used SVM with a polynomial kernel from R's e1071 package.

One or more examples include an operator inspecting the pills' shapes manually after applying the image operators from Equation 1. None of the binary shapes have any distortion or abnormalities. An example of an initial capsule image and its corresponding segmented shape image are provided in FIGS. 2 and 3, respectively. Thus, the shapes of the pills are accurate.

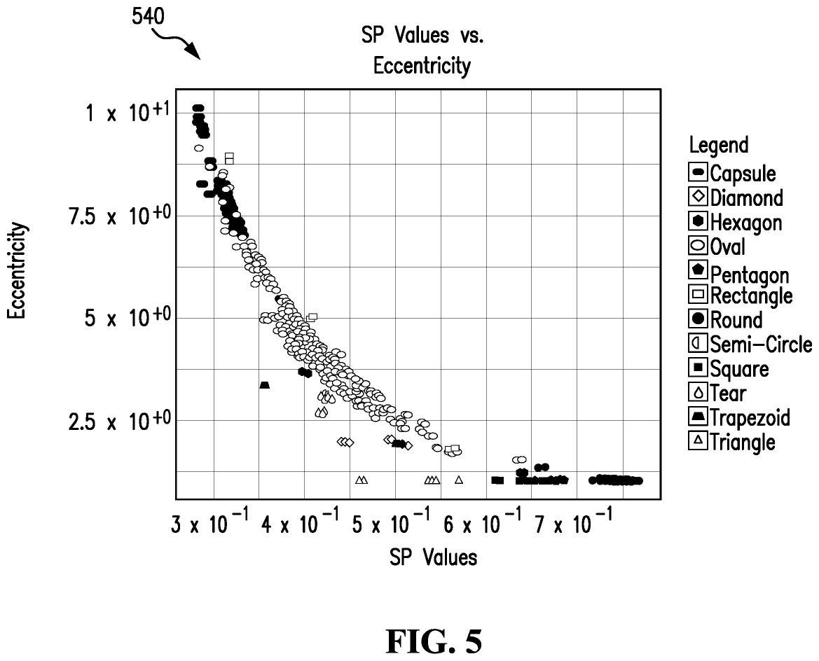

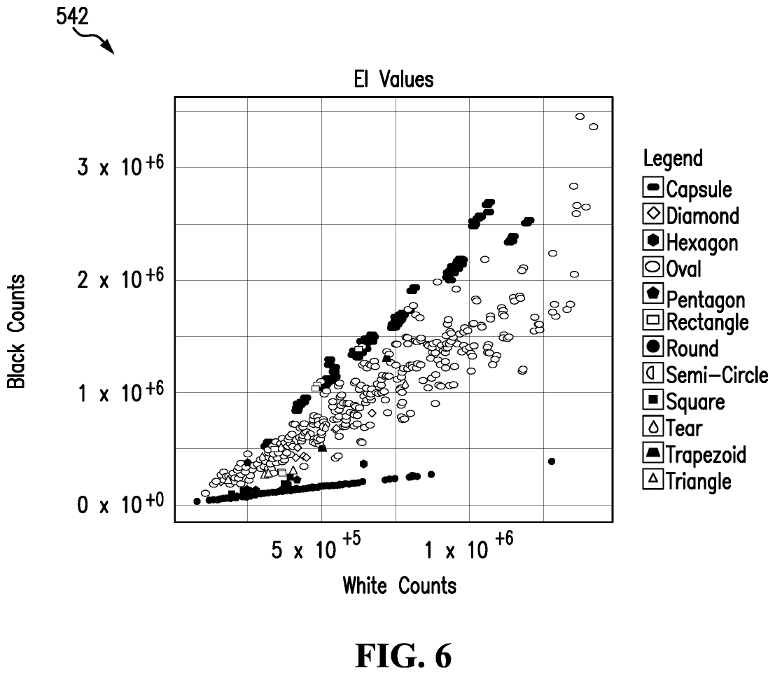

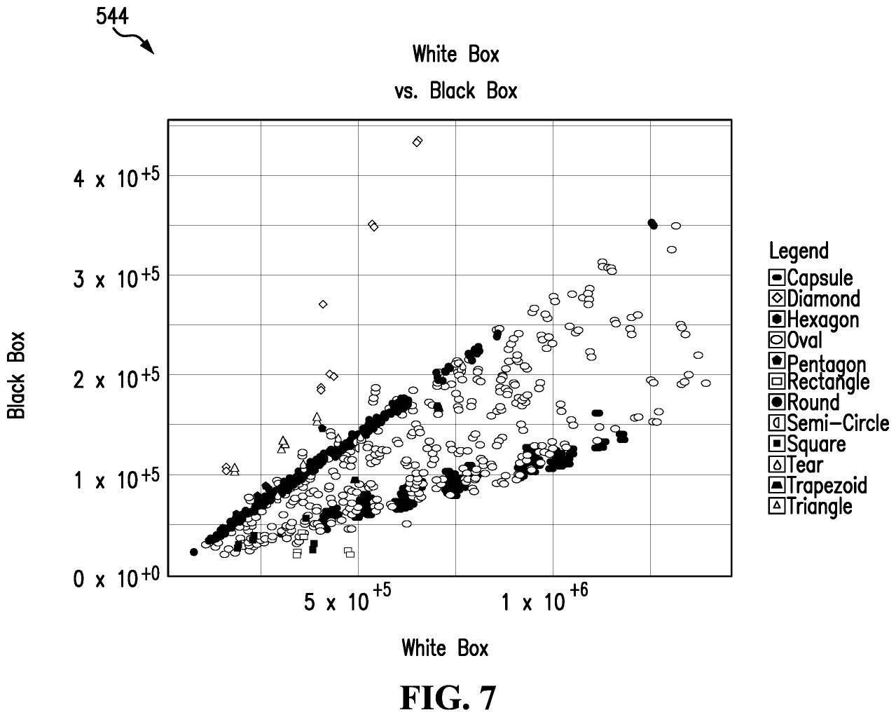

FIGS. 5 through 7 provide scatter plots 540, 542, 544 of the observations alongside some of the metrics. Upon inspection of the scatter plots 540, 542, 544, groups of classes are clearly separable. For example, in FIG. 5, the oval, rectangle, round, and capsule classes are clearly separable from the other remaining classes. Thus, by subdividing the classification task into a series of easier classification tasks, embodiments build an effective pill shape classification model.

The final model was an HMH decision tree where each decision node used only two variables and an SVM classification algorithm using a polynomial kernel. The parameter values for each node are provided in Table 3. This approach provides an interpretable and accurate model.

TABLE 3

| SVMⁱ | Cost | coef() | Degree |
|---|---|---|---|
| 1 | 1 | 2 | 5 |
| 2 | 1 | 1 | 2 |
| 3 | 1 | 1 | 3 |
| 4 | 1 | 1 | 1 |
| 5 | 1 | 50 | 2 |
| 6 | 1 | 1 | 10 |
| 7 | 1 | 2 | 10 |

Table 3 shows five SVM algorithms with associated polynomial kernel parameter values.

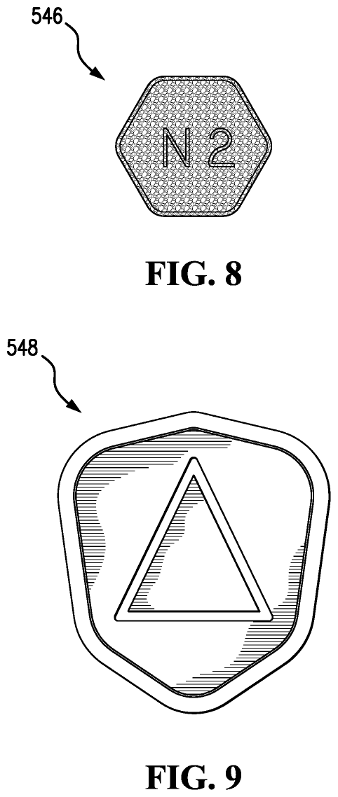

One or more examples utilize stratified random sampling for splitting the data to the training and validation data. The basic idea behind stratified random sampling is to reduce the error in our estimation, parameter, or modeling accuracy by partitioning a class into appropriate strata. One or more embodiments treated each of the classes as individual stratum except for the hexagon class. One or more embodiments split the hexagon class into two strata. There were two non-regular hexagons and six regular hexagons. Examples of the regular and non-regular hexagon observations 546, 548 are provided in FIGS. 8 and 9, respectively. One or more embodiments include one non-regular hexagon and three regular hexagons in the training data set. The final counts of the training and validation sets are provided in Table 4.

Table 4 shows counts for the training and validation data sets. There were two non-regular hexagons and six regular hexagons. Thus, one non-regular hexagon and three regular hexagons were randomly sampled. The other classes were treated as individual stratum. Those observations in the stratum were randomly assigned to the training data.

TABLE 4

| Class | Training Count | Validation Count |
|---|---|---|
| Capsule | 25 | 307 |
| Diamond | 6 | 6 |
| Hexagon | 4 | 4 |
| Oval | 25 | 661 |
| Pentagon | 6 | 6 |
| Rectangle | 3 | 3 |
| Round | 25 | 881 |
| Semi-Circle | 2 | 2 |
| Square | 4 | 4 |
| Tear | 5 | 5 |
| Trapezoid | 2 | 2 |
| Triangle | 6 | 6 |
| Total | 113 | 2000 |

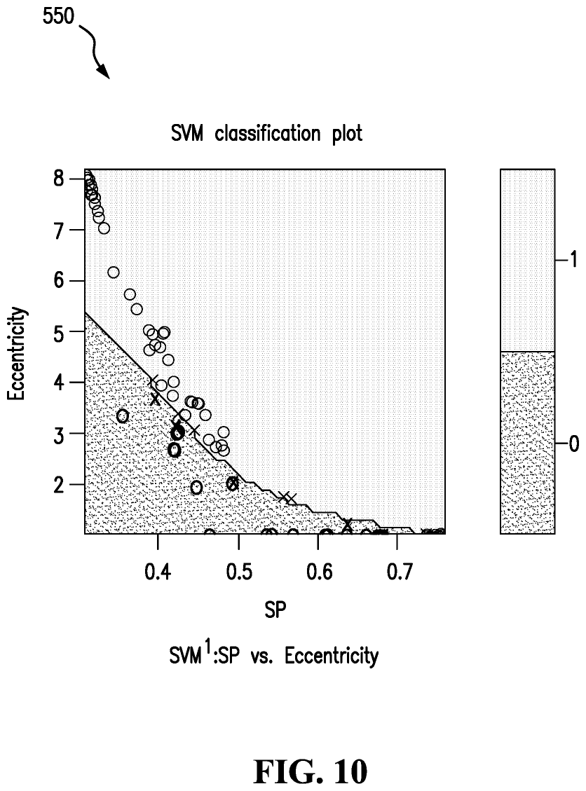

FIG. 10 shows an SVM classification plot 550 the decision boundary made using the training data on the first decision node. This model used the SVM algorithm with a polynomial kernel with the associated parameter values of SVM¹ which is found in Table 3. The lighter points are associated with oval, round, rectangle, and capsule observations. The darker points correspond to the other classes. The “Xs” indicate if the model used the observation as a support vector, while the open circles are not support vectors. Each node of the decision tree can have this kind of 2D plot made. Modelers and users can utilize these plots to better understand the decision-making process of the HMH decision tree making the model highly interpretable.

FIG. 10 provides an example of the results of the first decision node in the decision tree. We were able to classify the first two meta-classes perfectly using SP and eccentricity. The first meta-class was oval, capsule, rectangle, and round. The second meta-class included the remaining classes. While FIG. 10 presents only the training data, the node was also able to perfectly classify the validation data as well.

Interpreting the decision boundary in FIG. 10 is straightforward. The round, capsule, oval, and rectangle classes range from having large SP values with small eccentricity to small SP values with large eccentricity. The second meta-class tends to have smaller SP and eccentricity values. This process of interpreting each node of the tree is repeatable.

One of the metrics used to evaluate the models was mean precision (MP). Precision is defined to be:

$$Precision = \frac{True Positives}{True Positives + False Positives}$$

Mean precision (MP) is the mean precision value across all of the given classes. For example, if the precisions of a binary classifier was 1.0 and 0.0, then the MP is:

$$M P = \frac{1.0 + 0.0}{2} = 0.5$$

MP is a better measure for problems with multiple classes since it captures the precision of the model for each class in a single value. This simplifies evaluating problems with numerous classes into a single value.

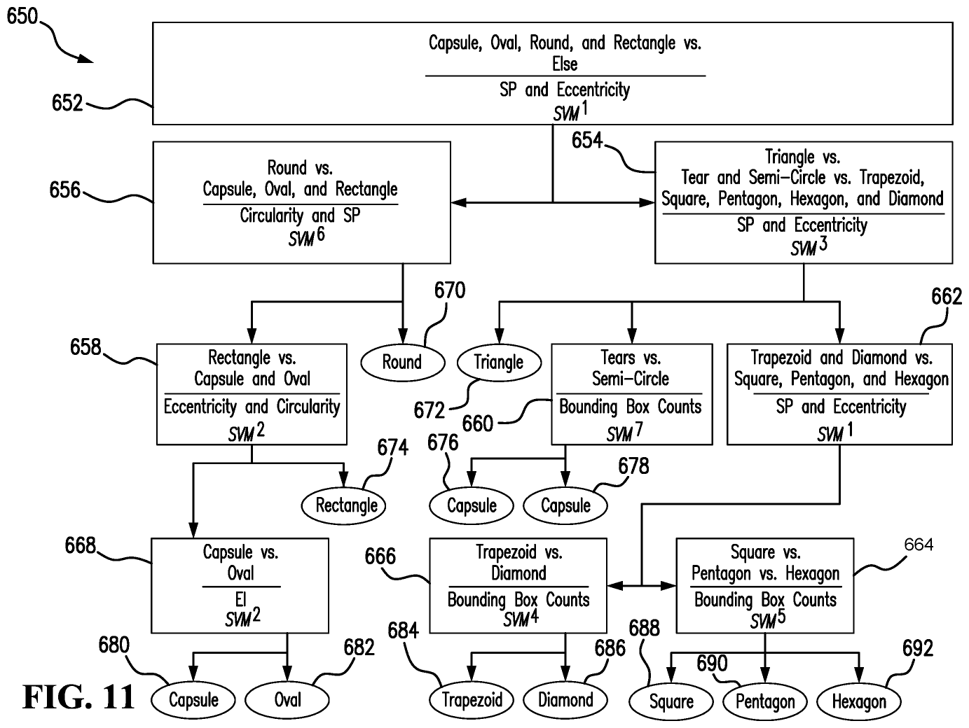

FIG. 11 shows a resulting decision tree 650. Each decision node 652, 654, 656, 658, 660, 662, 664, 666, 668 of the decision tree 650 may use a different SVM with a polynomial kernel that processes various parameter values. Table 3 summarizes those kernel values. The decision nodes 652, 654, 656, 658, 660, 662, 664, 666, 668 are shown in rectangles. The leaves (i.e., decisions) are found in ovals that represent the final decision nodes 670, 672, 674, 676, 678, 680, 682, 684, 686, 688, 690, 692. The final decision nodes 670, 672, 674, 676, 678, 680, 682, 684, 686, 688, 690, 692 classifies the class. The decision tree 650 correctly classified all of the classes. The decision tree 650 may encounter difficulties discriminating between capsules and ovals, in which case a system that implements the above decision tree 650 may notify a human operator that a capsule and/or oval is present, and/or utilize other characteristics (e.g., text, color etc.) to verify the shape.

For example, pills may be manufactured in various standard sizes and shapes depending on the type of pill and the medicine administered (e.g., extended release capsules pills versus immediate release round pills). Text on the bills may be unique. Thus, the text may be extracted, compared against a database to identify the pill and the shape may be verified against an expected shape of the pill listed in the database.

One or more embodiments may include other classification algorithms that may be used at each decision node 652, 654, 656, 658, 660, 662, 664, 666, 668. For example, the first decision node 652 in FIG. 11 may be built using the SP and eccentricity variables, but with a neural network (e.g., an AI system). Thus, other classification algorithms can be replaced at each parent node.

Several other machine-driven models were built for comparison. One or more embodiments build three SVM models utilizing a grid search for their parameters. The three models each used a different kernel. The kernels were polynomial, radial, and sigmoid. We also built naive Bayes and Linear Discriminant Analysis (LDA) models. The Mean Precision (MP) values for all the models are provided in Table 5. This table also includes the MP values for two of Maddala et al.'s models and embodiments of the present HMH model. The HMH model of the present embodiments provide the largest MP value, which indicates that our model performs best across all of the classes.

The first and third columns of Table 5 correspond to the model name. The second and fourth rows correspond to the MP values. The first model is an SVM with a polynomial kernel (SVM—P). The second model is an SVM with a radial kernel (SVM—R). The third model is an SVM with a sigmoid kernel (SVM—S). The fourth model is an NB, and the fifth model is an LDA. The sixth model is the HMH adaptable tree built by Maddala et al. The seventh model is the logistic regression (LR) built by Maddala et al. using Hu moments. The eighth model is an HMH decision tree that operates according to the present disclosure and embodiments as described herein. Maddala—LR does not have a MP value since it does not predict classes. Since our approach has the largest MP, our approach performs best across all of the classes. This corresponds to an average out performance of 101.06%.

TABLE 5

| Method | SVM-P | SVM-R | SVM-S | NB | LDA |
|---|---|---|---|---|---|
| MAP | 0.355 | 0.757 | 0.269 | 0.623 | 0.801 |
| Method | Maddala- | Maddala- | Lambreti- | — | — |
| | Tree | LR | Tree | | |
| MAP | 0.897 | — | 0.984 | — | — |

First, the below will discuss the HMH decision tree's out performance of other approaches. Second, the below will mention the importance of the SP and eccentricity values for the decision tree. Third, the below will discuss how our image segmentation treated the data better. Fourth, the below will how this approach is a hybrid of a human guided model and a machine learning model.

One or more embodiments as described herein are more accurate across all of the classes as compared to CNNs and other models such as Maddala et al. The mean average precision in present embodiments is 98.4%, while Maddala et al.'s was 89.7% on the complete data. This corresponds to a 9.7% out performance across all of the classes. In examples, a class corresponds to different groups of pills.

Additionally, present embodiments outperform all other attempted approaches. This corresponds to a mean out performance rate of 101.6%. Ultimately, present embodiments are substantially more interpretable and accurate across all of the classes.

The first decision node 652 in the decision tree used only the SP values and eccentricity. The addition of the SP value proved invaluable. No other pair of metrics was able to provide the first step to make classification possible. Thus, the SP value and the well-established metric of eccentricity were of paramount importance for making the classification of these observations possible. If these metrics were not used, converting this problem to a large data solution would likely be inevitable. Examples include performing data augmentation or collecting more data. These two metrics allowed some embodiments to provide a small data solution.

A major issue with Maddala et al.'s solution using adaptable rings is that the image segmentation required the prior knowledge of the classes. Thus, they were essentially measuring two groups of classes in two different manners. Present embodiments require only one image segmentation algorithm and was able to accurately capture each pill's shape. Thus, present embodiments are able to capture the shape of all of the pill shape observations in a uniform and unbiased manner.

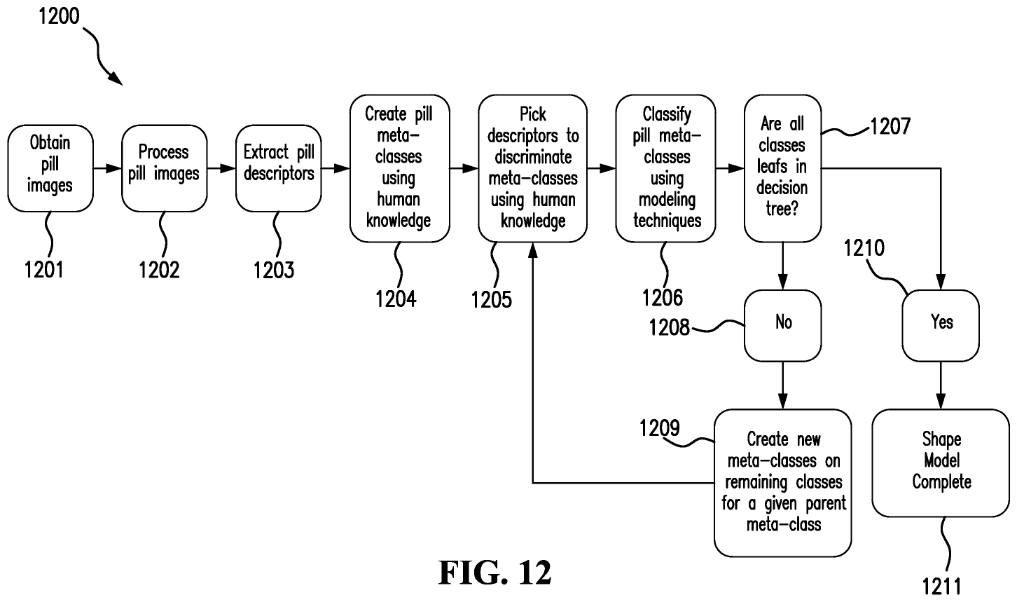

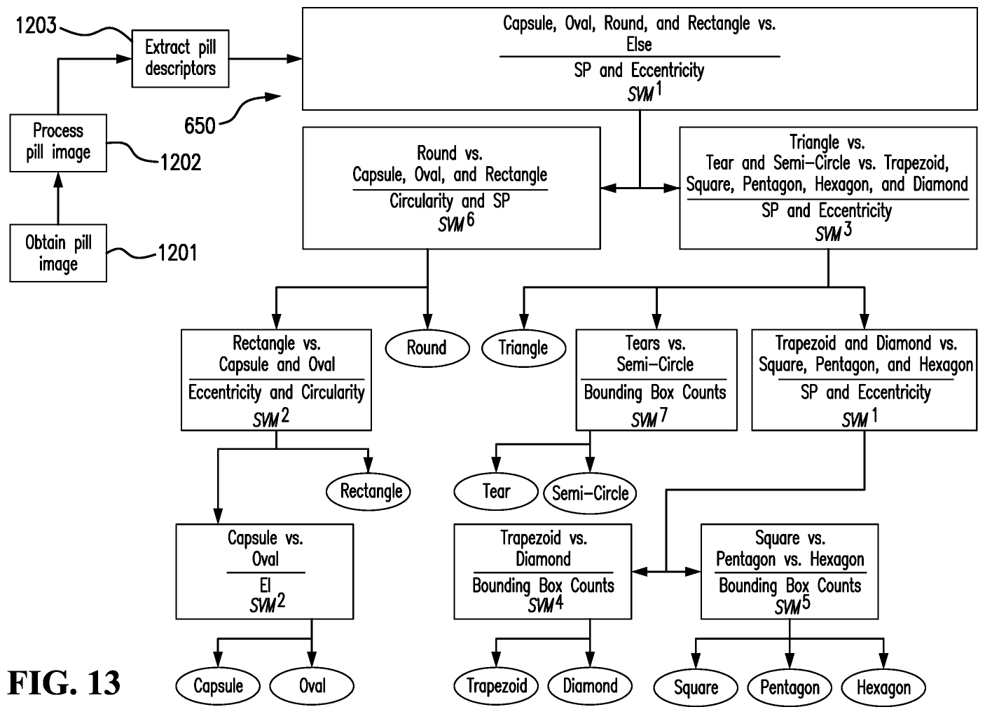

FIG. 12 is a flow diagram illustrating an overall supervised learning process 1200 implemented by embodiments of the present application to generate an HMH decision tree. The process 1200 begins at 1201 where pill images are obtained. As mentioned, this may be accomplished using any number of cameras, including smart phone cameras. In a clinic setting, the camera may be positioned above a sample stage and operated either manually or automatically. Images from the camera are processed at 1202 to permit the extraction of pill descriptors at 1203. The processes at 1202 and 1203 are performed by computer using well understood image processing techniques. Then, at 1204, pill meta-classes are created using human knowledge and, at 1205, descriptors are picked to discriminate meta-classes using human knowledge. At this point the pill meta-classes are classified using modeling techniques installed on the computer. At this point in the process, a decision is made at 1207 as to whether all training for the classes' leafs (e.g., based on whether the leaf accurately discriminates between shapes in model validation testing) in the decision tree shown in FIG. 11 are completed. If not, output at 1208, new meta-classes are created on the remaining classes for a given parent meta-class at 1209, and the process returns to 1205. On the other hand, if the decision at 1207 is output 1210, the shape model is complete at 1211.

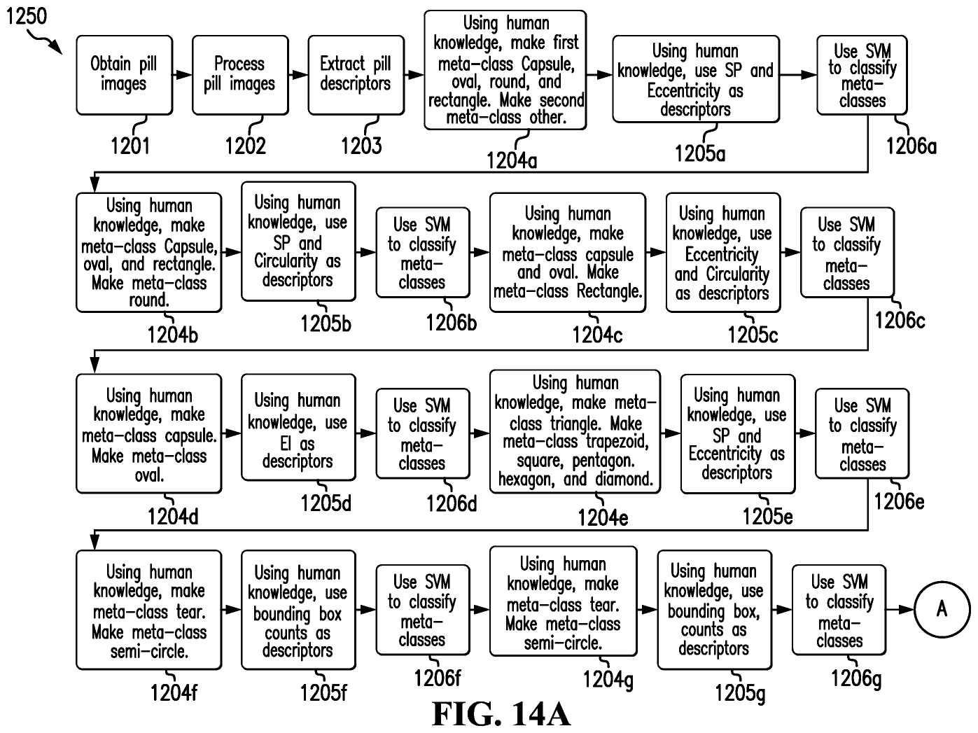

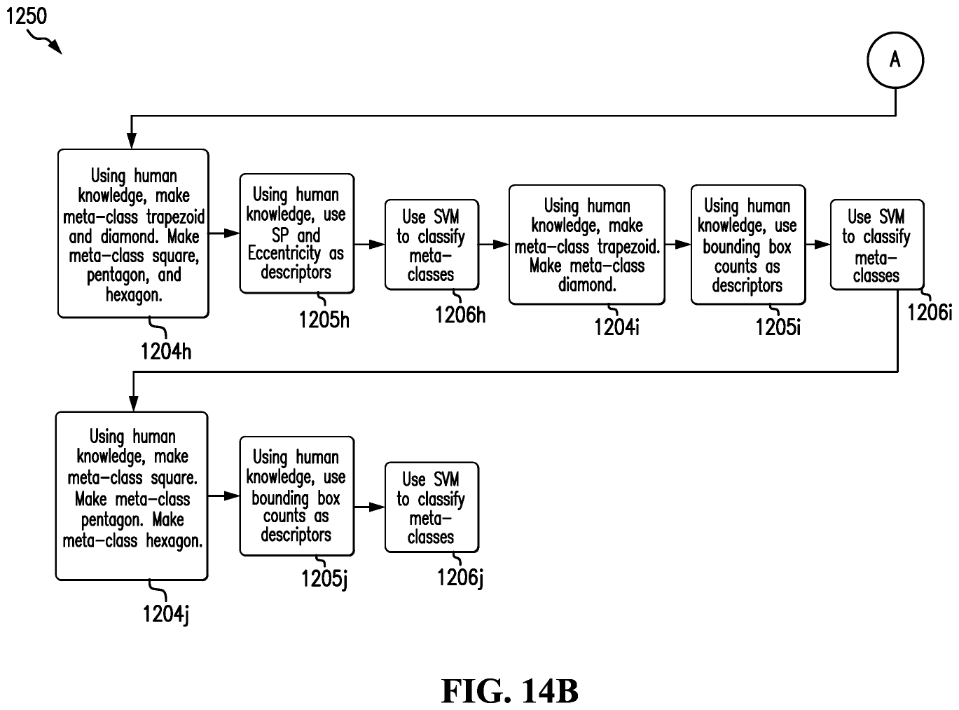

FIG. 13 elaborates on the process of FIG. 12 illustrating the point at which the decision tree 650 (see FIG. 11) is generated. The reference numerals of FIG. 13 represent the same elements as in FIGS. 11 and 12. The decision tree of FIG. 11 is generated at elements 1204 and 1205 using a Human Machine Hybrid (HMH) process 1250, which is shown in more detail in FIGS. 14A and 14B.

FIGS. 14A and 14B, it will be observed that the process 1250 is a recursive process. Again, the reference numerals of FIGS. 14A and 14B represent the same or similar elements (e.g., sub-components) as in FIG. 12. So, for example, 1204a uses human knowledge to make a first meta-class of “capsule, oval, round, and rectangle,” and meta-class “other.” Then, 1205a uses human knowledge to designate SP and eccentricity as descriptors. A support vector machine (SVM) is used at 1206a to classify meta-classes. Then, again, at 1204b, human knowledge is used to make meta-class “capsule, oval, and rectangle” and to make meta-class “round.” At 1205b, human knowledge is used to designate SP and circularity as descriptors. A SVM is used at 1206b to classify meta-classes. At 1204c, human knowledge is used to make meta-class “capsule and oval” and to make meta-class “rectangle”. Then, 1205c uses human knowledge to designate SP and eccentricity and circularity as descriptors. A SVM is used at 1206c to classify meta-classes. At 1204d, human knowledge is used to make meta-class “capsule and oval” and to make meta-class “rectangle.” Then, 1205d uses human knowledge to designate SP and eccentricity and circularity as descriptors. A SVM is used at 1206d to classify meta-classes.

At 1204e, human knowledge is used to make meta-class “triangle” and to make meta-class “trapezoid, square, pentagon, hexagon and diamond.” Then, 1205e uses human knowledge to designate EI as descriptors. A SVM is used at 1206e to classify meta-classes. At 1204f, human knowledge is used to make meta-class “tear” and to make meta-class “semi-circle”. Then, 1205f uses human knowledge to designate SP and eccentricity as descriptors. A SVM is used at 1206f to classify meta-classes. At 1204g, human knowledge is used to make meta-class “tear” and to make meta-class “semi-circle”. Then, 1205g uses human knowledge to use bounding box counts as descriptors. Then, 1206g uses SVM to classify meta-classes.

Turning to FIG. 14B, at 1204h, human knowledge is used to make meta-class “trapezoid and diamond” and to make meta-class “square, pentagon and hexagon.” Then, 1205h uses human knowledge to use SP and eccentricity as descriptors. A SVM is used at 1206h to classify meta-classes. Next, at 1204i, human knowledge is used to make meta-class “trapezoid” and to make meta-class “diamond.” Then, 1205i uses human knowledge to use human knowledge to use bounding box counts as descriptions. A SVM is used at 1206i to classify meta-classes. At 1204j, human knowledge is used to make meta-class “square,” meta-class “pentagon,” and to make meta-class “hexagon.” Then, 1205j uses human knowledge to use bounding box counts as descriptors. A SVM is used at 1206j to classify meta-classes.

Once the general system of FIG. 12 has been implemented by generating the decision tree of FIG. 11, the system is ready to perform pill identification. This process 1252 is generally shown in FIG. 15. As in FIG. 12, the operation begins by obtaining pill images at 1201. Again this can be done in a variety of ways, including a fixed photographic station include a sample stage and a less elaborate approach based on a smart phone. In any case, the pill image is input to the computer which first processes the input pill image at 1202 and then extracts pill descriptors at 1203. The process of generating the decision tree of FIG. 11 and as described with reference to FIGS. 14A and 14B produces a database which the computer can access using the pill descriptors extracted at 1203.

FIG. 15 illustrates a complete system implementing embodiments as described herein. The computer obtains a result from shape classification at 151 based on the decision tree of FIG. 11. The computer obtains a result from color identification at 152. Color identification can be accomplished, for example, with a convolution neural network to recognize the color(s) of a given object. The recognized color(s) would then be computed into a similarity score with potential matches from a database. The computer obtains a result from text identification at 153. Again, a convolution neural network can be used to recognize each character (if any) in an image, and then words associated with the recognized characters would be constructed. The recognized words would then be computed into a similarity score with potential matches from a database. These results from shape classification 151, color identification 152, and text identification 153 are combined at 154 to identify the pill from the database of known pills. The outputs of these three models are combined via a similarity score using a reference database. The observation which has the highest similarity is the predicted pill.

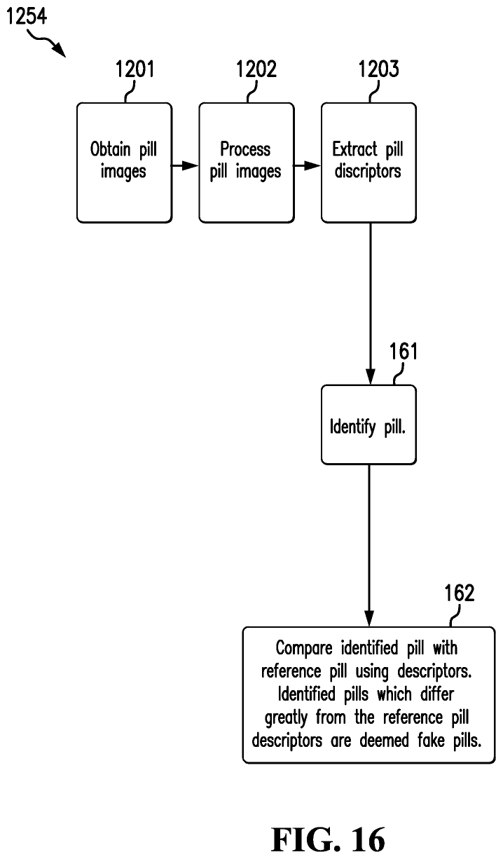

An important variation of the use in some embodiments is illustrated in process 1254 of FIG. 16. Specifically, at 161 a pill is identified as in FIG. 15; however, the identified pill is compared at 162 with a reference pill using the descriptors. Identified pills which differ greatly from the reference pill descriptors are deemed fake pills, and the computer provides an output indicating the pill in question is not legitimate.

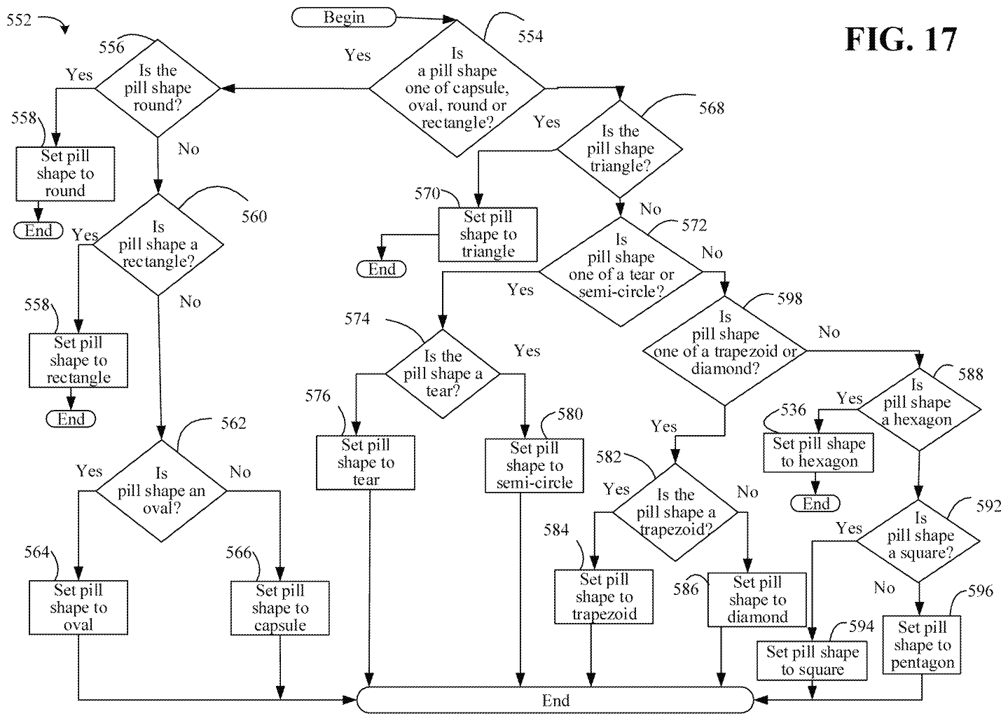

FIG. 17 illustrates a method 552 for detecting a pill shape. The method 552 may generally be implemented in conjunction with any of the embodiments described herein. In an embodiment, the method 552 is implemented in logic instructions (e.g., software), configurable logic, fixed-functionality hardware logic, circuitry, etc., or any combination thereof.

Each of illustrated processing blocks 554, 556, 560, 562, 568, 572, 574, 598, 582, 588, 592 may be a node of a decision tree that uses a different SVM with a polynomial kernel with various parameter values to generate a decision. Thus, each of the processing blocks 554, 556, 560, 562, 568, 572, 574, 598, 582, 588, 592 may execute a binary decision.

Processing block 554 determines if the pill shape of a pill is one of capsule, oval, round or rectangle. For example, illustrated processing block 556 classifies the pill shape as being in a first group (e.g., capsule, oval, round or rectangle) or a second group (any other shape). If the pill shape is in the first group, illustrated processing block 556 determines if the pill shape is round. If so, illustrated processing block 558 sets the pill shape to round. Otherwise, illustrated processing block 560 determines if the pill shape is a rectangle. If so, illustrated processing block 558 sets the pill shape to a rectangle. Otherwise, illustrated processing block 562 determines if the pill shape is an oval. If so, illustrated processing block 564 sets the pill shape to oval. Otherwise, illustrated processing block 566 sets the pill shape to a capsule.

Returning back to illustrated processing block 554, if the pill shape is not one of a capsule, oval, round, or rectangle, illustrated processing block 568 determines if the pill shape is a triangle. If so, illustrated processing block 570 sets the pill shape to a triangle. Otherwise, illustrated processing block 572 determines if the pill shape is one of a tear or a semi-circle. If so, illustrated processing block 574 determines if the pill shape is a tear. If so, illustrated processing block 576 sets the pill shape to the tear. Otherwise, illustrated processing block 580 sets the pill shape to semi-circle. If processing block 572 determines that the pill shape is not one of a tear or a semi-circle, illustrated processing block 598 determines if the pill shape is one of a trapezoid or diamond. If so, illustrated processing block 582 determines if the pill shape is a trapezoid. If so, illustrated processing block 584 sets the pill shape to trapezoid. Otherwise, illustrated processing block 586 sets the pill shape to a diamond.

Otherwise, if illustrated processing block 598 determines that the pill shape is not one of a trapezoid or diamond, illustrated processing block 588 determines if the pill shape is a hexagon. If so, illustrated processing block 536 sets the pill shape to hexagon. Otherwise, if the pill shape is not a hexagon, illustrated processing block 592 determines if the pill shape is a square. If so, illustrated processing block 594 sets the pill shape to a square. Otherwise, illustrated processing block 596 sets the pill shape to pentagon.

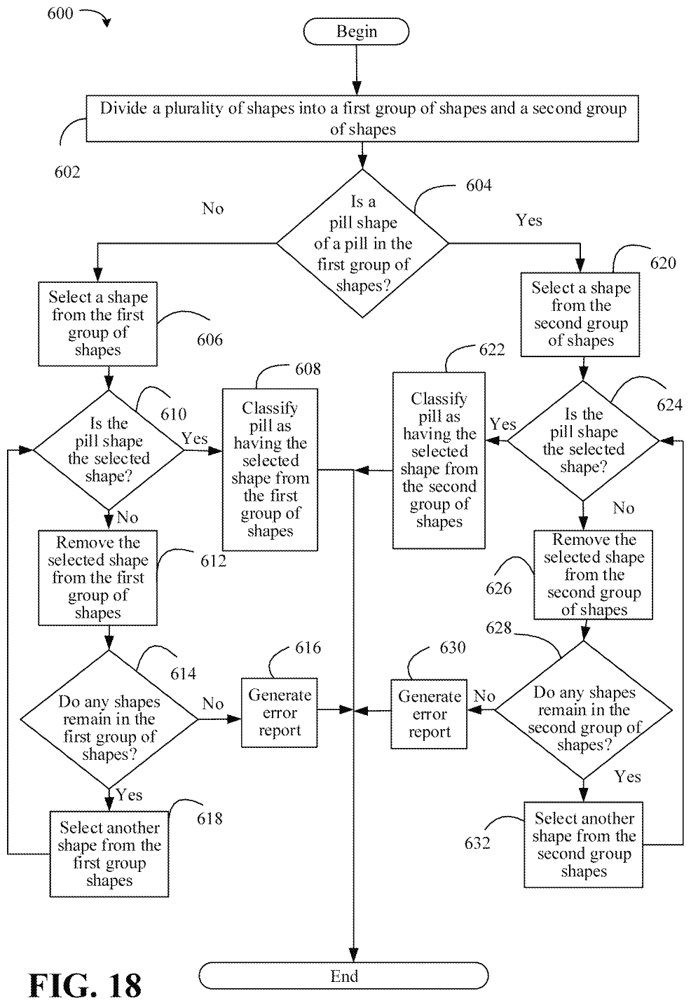

FIG. 18 illustrates a method 600 for detecting a pill shape. The method 600 may generally be implemented in conjunction with any of the embodiments described herein. In an embodiment, the method 600 is implemented in logic instructions (e.g., software), configurable logic, fixed-functionality hardware logic, circuitry, etc., or any combination thereof.

Illustrated processing block 602 divides a plurality of shapes into a first group and a second group. Illustrated processing block 604 determines if a pill shape of a pill is in the first group of shapes. If not, illustrated processing block 606 selects a shape from the first group of shapes. Illustrated processing block 610 determines if the pill shape is the selected shape. If so, illustrated processing block 608 classifies the pill as having the selected shape from the first group of shapes. If not, illustrated processing block 612 removes the selected shape from the first group of shapes. Illustrated processing block 614 determines if any shapes remain in the first group of shapes. If so, illustrated processing block 618 selects another shape from the first group of shapes and processing block 610 executes again in an iterative process. If processing block 614 determines that no shapes remain, then no match has been found before all shapes are removed. Thus, illustrated processing block 614 generates an error report.

If processing block 604 determines that the pill shape is in the second group of shapes. If so, illustrated processing block 620 selects a shape from the second group of shapes. Illustrated processing block 624 determines if the pill shape is the selected shape. If so, illustrated processing block 622 classifies the pill as having the selected shape from the second group of shapes. If not, illustrated processing block 626 removes the selected shape from the second group of shapes. Illustrated processing block 628 determines if any shapes remain in the second group of shapes. If so, illustrated processing block 632 selects another shape from the second group of shapes and processing block 610 executes again in an iterative process. If processing block 628 determines that no shapes remain, then no match has been found before all shapes are removed. Thus, illustrated processing block 630 generates an error report.

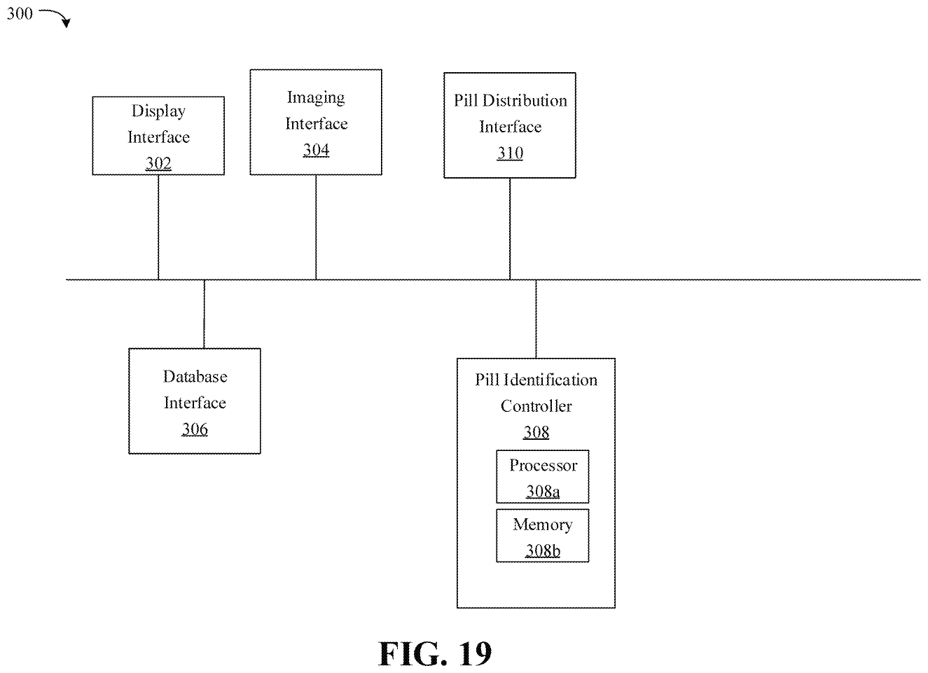

FIG. 19 shows a more detailed example of a pill processing system 300 of a computing device to identify a type of the pill (e.g., clearly identify a type of the pill, strength of dosage, shape, etc.) and distribute the pill accordingly. the first, second and third operational modes. The illustrated pill processing system 300 may be readily implemented in any of the apparatuses, methods and/or processes discussed herein.

In the illustrated example, the pill processing system 300 may include a display interface 302. The display interface 302 may allow for communications between the pill identification controller 308 and users (e.g., humans) to provide updates to pill processing, notifications of errors due to inability of classification, etc. The display interface 302 may operate over various wireless and/or wired communication channels to communicate with a display and/or auditory device, and in some examples may include an auditory output in addition to or instead of visual outputs.

The system 300 may further include an imaging interface 304 that retrieves images of a pill for further processing. The system 300 may also include a database interface 306 to retrieve pill data associated with pills from a database. As already explained, characteristics of a pill may be compared to the database to identify the type of the pill.

The system 300 may also include a pill identification controller 308. The pill identification controller 308 may include a processor 308a (e.g., embedded controller, central processing unit/CPU, circuitry, etc.) and a memory 308b (e.g., non-volatile memory/NVM and/or volatile memory) containing a set of instructions, which when executed by the processor 308a, cause the pill identification controller 308 to identify characteristics of a pill from images received by the imagine interface 304. The pill identification controller 308 may then take actions based on the identified characteristics, such as categorizing the pill with reference to the database, and notifying a user of the results of the categorization via the display interface 302.

The pill identification controller 308 further includes a pill distribution interface 310 that distributes pills based on the categorization of the pill identification controller 308. For the example, the pill identification controller 308 may dispense pills into containers for retrieval by a user. If however the categorization of the pill identification controller 308 is unexpected, the pill distribution interface 310 may withhold distribution of the pill. For example, the pill identification controller 308 may have a request to distribute “pill A” (e.g., Aspirin). If the pill identification controller 308 cannot affirmatively identify a pill being processed as being pill A, the pill distribution interface 310 may not distribute the pill being processed, and instead hold the pill for further processing, and/or place the pill into an internal storage area.

In some examples, the pill identification controller 308 compares a shape of a pill to be processed with a shape of a reference pill in the database. The reference pill may be identified based on text or color of the pill to be processed (e.g., text compared to the database to determine the reference pill, and retrieve an expected shape of the reference pill). If upon determining the pill to be processed differs greatly from a reference pill in the database, the pill identification controller 308 provides a user with an indication that the pill to be processed is a fake pill through the display interface 302.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present examples can be implemented in a variety of forms. Therefore, while the embodiments of this example have been described in connection with particular examples thereof, the true scope of the embodiments of the example should not be so limited since other modifications will become apparent to the skilled practitioner upon a study of the drawings, specification, and following claims.

What is claimed is:

1. A pill shape classification system, comprising:
an imaging device to obtain one or more pill images of a pill to be processed;
at least one processor; and
at least one memory having a set of instructions, which when executed by the at least one processor, causes the pill shape classification system to:
extract one of more features from the one or more pill images; and
classify the one or more features into one or more classifications based on a decision tree having a plurality of nodes and a plurality of leafs, each node using a classification algorithm, and each node pointing directly or indirectly to one or more of the plurality of leafs uniquely describing a classification that includes a pill shape, a pill text, or a pill color.

2. The pill classification system of claim 1, wherein the classification algorithms are support vector machines (SVMs).

3. The pill classification system of claim 1, wherein one or more of the classification algorithms is a neural network.

4. The pill classification system of claim 1, wherein respective leafs of the decision tree identify pill shapes as one of round, triangle, rectangle, tear, semi-circle, capsule, oval, trapezoid, diamond, square, pentagon, or hexagon.

5. The pill classification system of claim 1, wherein the set of instructions, which when executed by the at least one processor, causes the pill shape classification system to compare a shape of the pill to be processed with a shape of a reference pill in a database and, if upon determining the pill to be processed differs greatly from a reference pill in the database, provides a user with an indication that the pill to be processed is a fake pill.

6. The pill classification system of claim 1, wherein the set of instructions, which when executed by the system, cause the pill shape classification system to output the one or more classifications to a display device.

7. The pill classification system of claim 1, wherein the one or more classifications includes a pill shape of the pill to be processed, a pill text of the pill to be processed and a pill color of the pill to be processed.

8. The pill classification system of claim 1, wherein the set of instructions, which when executed by the at least one processor, cause the pill shape classification system to identify a name and dosage of the pill to be processed based on the one or more classifications.

9. A method of classifying one or more pills, the method comprising:
obtaining one or more pill images of a pill to be processed;
extracting one of more features from the one or more pill images; and
classifying the one or more features into one or more classifications based on a decision tree having a plurality of nodes and a plurality of leafs, each node using a classification algorithm, and each node pointing directly or indirectly to one or more of the plurality of leafs uniquely describing a classification that includes a pill shape, a pill text, or a pill color.

10. The method of claim 9, wherein the classification algorithms are support vector machines (SVMs).

11. The method of claim 9, wherein one or more of the classification algorithms is a neural network.

12. The method of claim 9, wherein respective leafs of the decision tree identify pill shapes as one of round, triangle, rectangle, tear, semi-circle, capsule, oval, trapezoid, diamond, square, pentagon, or hexagon.

13. The method of claim 9, further comprising:
comparing a shape of the pill to be processed with a shape of a reference pill in a database; and
if upon determining the pill to be processed differs greatly from a reference pill in the database, providing a user with an indication that the pill to be processed is a fake pill.

14. The method of claim 9, further comprising outputting the one or more classifications to a display device.

15. The method of claim 9, wherein the one or more classifications includes a pill shape of the pill to be processed, a pill text of the pill to be processed and a pill color of the pill to be processed.

16. At least one computer readable storage medium comprising a set of instructions, which when executed by a computing device, causes the computing device to:
obtain one or more pill images of a pill to be processed;
extract one of more features from the one or more pill images; and
classify the one or more features into one or more classifications based on a decision tree having a plurality of nodes and a plurality of leafs, each node using a classification algorithm, and each node pointing directly or indirectly to one or more of the plurality of leafs uniquely describing a classification that includes a pill shape, a pill text, or a pill color.

17. The at least one computer readable storage medium of claim 16, wherein the classification algorithms are support vector machines (SVMs).

18. The at least one computer readable storage medium of claim 16, wherein one or more of the classification algorithms is a neural network.

19. The at least one computer readable storage medium of claim 16, wherein respective leafs of the decision tree identify pill shapes as one of round, triangle, rectangle, tear, semi-circle, capsule, oval, trapezoid, diamond, square, pentagon, or hexagon.

20. The at least one computer readable storage medium of claim 16, wherein the instructions, when executed, cause the computing device to:
compare a shape of the pill to be processed with a shape of a reference pill in a database; and
if upon determining the identified pill differs greatly from a reference pill in the database, provide a user with an indication that the pill to be processed is a fake pill.
